(19) United States
(12) Patent Application Publication
(10) Pub. No.: US 2007/0209818 A1
(43) Pub. Date: Sep. 13, 2007

(54) Nonmetallic electrical outlet box repair device

(76) Inventors: Howard Forrest, Powder Springs, GA (US); James A. Welch, Norcross, GA (US)

Correspondence Address: GEORGE R. REARDON, 3356 STATION COURT, LAWRENCVILLE, GA, 30044, US

(21) Appl. No.: 11/372,864

(22) Filed: Mar. 10, 2006

(51) Int. Cl. H02G 3/08

(52) U.S. Cl. 174/50

(57) ABSTRACT

A device that for repairing a nonmetallic electrical outlet box having one or more screw holes that are stripped, damaged or missing is described. The device provides a replacement screw tab with a screw hole, as well as side tabs that secure the device to a nonmetallic electrical outlet box.

### FIELD OF THE INVENTION

The present invention relates to the field of repair devices for an electrical apparatus. In particular, the present invention relates to a repair device for a nonmetallic electrical outlet box.

### BACKGROUND OF THE INVENTION

A common problem with nonmetallic electrical outlet boxes is that the screw hole thread gets enlarged and splits after repeated plugging and unplugging of electrical cords. This condition may be exacerbated if the unplugging is done improperly.

In order to remedy this situation the common solution is to go buy a replacement nonmetallic electrical outlet box, determine which circuit breaker or fuse controls the nonmetallic electrical outlet box needing repair, deactivate that circuit breaker or fuse, remove the cover plate that is attached to the electrical receptacle, remove the electrical receptacle securing screws, pull the electrical receptacle completely out from the box, label each of the wires in the outlet box, remove each of the wires from the electrical receptacle, remove the outlet box, replace the outlet box with a replacement outlet box, insert the wiring back into the new outlet box, attach each of the wires to the electrical receptacle, and reinstall the electrical receptacle and the cover plate. Another common solution is to call a licensed electrician.

Patents involving devices that engage outlet boxes include the following.

U.S. Pat. No. 5,639,991, issued to Gail D. Schuette on Jun. 17, 1997, discloses a protective insert for protecting wires and other contents of a utility box such as an electrical or communication wiring box, from damage during construction, particularly when cutting openings for such boxes in wallboard that has been placed onto studs. The insert is made to utilize the only standard dimensions in utility boxes, namely, the distance between the threaded bores used for fastening switches, receptacles or other fixtures. The protective insert is easily placed into utility boxes using two ribbed posts or shanks that fit into the openings of the box with a fit that retains the insert in place. The insert is easily removed, and it also protects the threaded bores in the box that are used for supporting switches, receptacles, light fixtures, or the like.

U.S. Pat. No. 5,526,952, issued to Robert L. Green on Jun. 18, 1996, discloses a temporary protective cover for nonmetallic electrical outlet boxes and the like which prevents the boxes from being covered with wall material during installation, prevents paint and plaster from entering the boxes during finishing operations, and also prevents electrical shock from contact with exposed wires. The cover is molded in one piece and is constructed of polymeric material. The cover is universally dimensioned to cover the box openings of all conventionally sized boxes and includes a base member for encasing electrical elements positioned in and extending outwardly from the boxes. A plurality of retaining members frictionally secures the cover over the box openings. A plurality of projections extends from the cover to indicate the location of the box openings, to mark the periphery thereof on drywall for subsequent cutting, and to prevent wire damage during cutting. A plurality of holes are also provided in the cover for receiving fasteners to provide further securement of the cover over the openings.

U.S. Pat. No. 5,936,199, issued to George P. Lutz on Aug. 10, 1999, discloses an apparatus for insulating an electrical box is used for removing an energized electrical device from an outlet box. A removable shield, which is made from electrically-insulating material, acts an insulating barrier between the outlet box and the electrical device terminals to prevent inadvertent shorting and shock and injury to the electrician. Preferably, a pair of shields which can be inserted along the sides of an exposed outlet box in the space between the electrical device and the outlet box. Each shield is sized so that it covers at least that portion of the side of the electrical device having the terminal screws. Once the shields are properly inserted, the electrical device can be grasped by the electrician and safely removed from the outlet box.

U.S. Pat. No. 6,103,974, issued to Jeffrey Erdfarb on Aug. 15, 2000, discloses a paint cover, including a) a plate having a front and rear surface; b) the front surface having a top, bottom and side portions; c) top, bottom, and side continuous outer edges which project rearward from the front surface, wherein the outer edge is curved and tapered; d) the rear surface having a top, bottom and side portions; and e) a flexible arm extending rearwardly from each of the side portions of the rear surface, wherein the arms upon insertion into an outlet assembly frictionally engage the inside of the assembly so as to extend a force to secure the paint cover to an outlet box.

U.S. Pat. No. 6,520,363 B1, issued to Joseph Sullivan on Feb. 18, 2003, discloses an electrical receptacle shield in the form of a thin sheet metal stamping for temporarily covering the front opening of a utility receptacle. The receptacle has free front edges that define a front profile having an inner perimeter. The shield has an outer peripheral section in an anterior plane, an inner section in a posterior plane, and an intermediate section that slopes between the inner section and the peripheral section. The peripheral and intermediate sections have a plurality of gaps with a plurality of catches extend outwardly through the gaps. The catches extend outwardly to the inner perimeter of the front edges. The shield is pressed into the receptacle opening, held in position by the catches, and pried out when no longer needed.

U.S. Pat. No. 6,653,566 B2, issued to Randy Petak and Jeffrey Shaw on Nov. 25, 2003, discloses a cover for pre-wired conduit boxes for use in installing sheet wall material around the conduit boxes, with or without mud rings having an opening and side walls, the conduit boxes having a front opening and spaced side walls and a back wall that define a cavity therein, and with fixtures and wiring contained therein. The cover is made from a puncture and ablation resistant material, such as steel, and has a face plate with a perimeter edge and apertures formed therethrough. The cover is sized to cover the front opening of the conduit box or the mud ring, and has arms extended rearwardly therefrom which are adapted to snugly engage with side walls of the conduit box of mud ring. The cover is preferable a unitary structure, and when the cover is placed over the front opening of the outlet box or mud ring, the perimeter of the cover provides a guide for a cutting tool, such as a router, which will allow a user to cut out an opening through the sheet material to complete installation of the wall sheet material. The cover is easily removable after the sheet wall material is installed and desired wall treatment (e.g. painting, wallpapering, etc.) is completed. The outlet boxes can be pre-wired with fixtures and wiring.

U.S. Pat. No. 6,867,369 B2, issued to Richard S. Wiggins on Mar. 15, 2005, discloses a temporary protective cover/guide for a universal electrical/communications box, said protective cover having a perimeter side wall, a recessed planar base, and a flange extending outwardly from the side wall such that it is preferably substantially planar and parallel to the planar base. The perimeter side wall and base and flange are of a size and shape to friction fit the recessed base within the box once electrical conductors are pulled into the box. The flange covers nearly all of the upper edge(s) of the box. The cover/guide can be readily attached or removed and provides protection against electrical shocks. In preferred form, at least the base of the cover/guide is transparent so that an inspector can readily view the electrical conductors without having to remove the cover. The cover/guide also functions to assist in marking where the electrical box is and to protect the components from damage and construction workers from electrical shock during the drywall phase of construction prior to installing the permanent electrical component and permanent cover plate.

While these patents and other previous methods have attempted to solve the problems that they addressed, none have utilized or disclosed utilizing a repair device that is designed to retrofit a nonmetallic outlet box with new screw attachment tabs where one or both of the original screw attachment tabs is no longer operable, as does embodiments of the present invention.

Therefore, a need exists for a nonmetallic electrical outlet box repair device with these attributes and functionalities. The nonmetallic electrical outlet box repair device according to embodiments of the invention substantially departs from the conventional concepts and designs of the prior art. It can be appreciated that there exists a continuing need for a new and improved nonmetallic electrical outlet box repair device which can be used commercially and/or domestically for repair of nonmetallic electrical outlet boxes. In this regard, the present invention substantially fulfills these objectives.

The foregoing patent and other information reflect the state of the art of which the inventors are aware and are tendered with a view toward discharging the inventors' acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a repair device for an electrical apparatus. In particular, the present invention relates to a device that repairs nonmetallic electrical outlet boxes where one or both of the screw attachment tabs are no longer usable.

The present invention is formed into a structure designed to be inserted onto a nonmetallic electrical outlet box and provide at least one new screw attachment tab. In one embodiment this structure has a tab support. Protruding from the tab support is a fastener tab with a threaded fastener hole that is positioned to align with the screw hole of a nonmetallic electrical outlet box. Also protruding from the tab support is two substantially parallel projections extend, called side tabs. In the preferred embodiment two sets of two substantially parallel projections extend. One set of the side tabs is positioned on one side of the screw tab and the other set of the side tabs is positioned on the other side of the fastener tab. Both sets of side tabs extend away from the fastener tab substantially perpendicular to the fastener tab. The separation between the top and bottom parallel projections of each set is sized such that the present invention fits snugly onto a nonmetallic electrical outlet box and aligns with the electrical box screw hole. These side tabs may be serrated to form cleats such that the position and angle of the serrations allow for the insertion of the present invention onto a nonmetallic electrical outlet box, but once inserted the present invention strongly resists being removed, due to the “digging in” of the serrations into the portion of the nonmetallic electrical outlet box where the present invention is inserted. This embodiment allows the user to insert one instance of the present invention at the top of a nonmetallic electrical outlet box to be repaired and a second instance of the present invention at the bottom of the same nonmetallic electrical outlet box to be repaired.

The present invention may be further comprised of side connecting bars to form one frame-like piece for repairing a nonmetallic electrical outlet box.

In some embodiments the present invention is stamped out without connecting bars such that two pieces are used to repair a nonmetallic electrical outlet box. These embodiments are called clip embodiments. In other embodiments the present invention is stamped out with the connecting bars such that one piece is used to repair a nonmetallic electrical outlet box. These embodiments are called ring embodiments. Some embodiments of the present invention may be made to fit on a single gang box, e.g. a ring embodiment or a clip embodiment, but other embodiments may be manufactured for multi gang boxes, e.g. a clip embodiment.

The present invention is preferably made from spring steel, but may also be made from plastic or other materials with appropriate material characteristics. The means for securing of the invention to the nonmetallic electrical outlet box may be from adhesives, friction from the snug fit, or from the serrations.

One aspect of the present invention is that it eliminates the need to remove a damaged nonmetallic electrical outlet box from the wall, thus eliminating potential damage to the wiring and the wall.

Another aspect of the present invention is that it can be made inexpensively.

Another aspect of the present invention is that it can be made of readily available materials.

Another aspect of the present invention is that it is easy to install.

Another aspect of the present invention is that it reduces repair time.

Another aspect of the present invention is that it reduces repair costs.

These and other features and advantages of the present invention will be presented in more detail in the following specification of the invention and the accompanying figures, which illustrate by way of example the principles of the invention.

There are additional features of the invention that will be described hereinafter an which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a perspective view of a nonmetallic electrical box repair device according to one embodiment of the present invention.

FIG. 2 illustrates a perspective view of one step of the installation process to repair a nonmetallic electrical outlet box according to one embodiment of the present invention.

FIG. 3 illustrates a perspective view of a subsequent step of the installation process to repair a nonmetallic electrical outlet box according to one embodiment of the present invention.

FIG. 4 illustrates a top plan view of a nonmetallic electrical outlet box repair device according to one embodiment of the present invention.

FIG. 5 illustrates a bottom plan view of a nonmetallic electrical outlet box repair device according to one embodiment of the present invention.

FIG. 6 illustrates a perspective view of a nonmetallic electrical outlet box repair device according to one embodiment of the present invention.

FIG. 7 illustrates a front plan view of a nonmetallic electrical outlet box repair device according to one embodiment of the present invention.

FIG. 8 illustrates a rear plan view of a nonmetallic electrical outlet box repair device according to one embodiment of the present invention.

FIG. 9 illustrates a left side plan view of a nonmetallic electrical outlet box repair device according to one embodiment of the present invention.

FIG. 10 illustrates a right side plan view of a nonmetallic electrical outlet box repair device according to one embodiment of the present invention.

FIG. 11 illustrates a perspective view of one step of the installation process to repair a nonmetallic electrical outlet box according to one embodiment of the present invention.

FIG. 12 illustrates a perspective view of a subsequent step of the installation to repair a nonmetallic electrical outlet box according to one embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a through understanding of the present invention. It will be apparent, however, to one skilled in the art, that the present invention may be practiced without some or all of these specific details. In other instances, well known operations have not been described in detail so not to unnecessarily obscure the present invention.

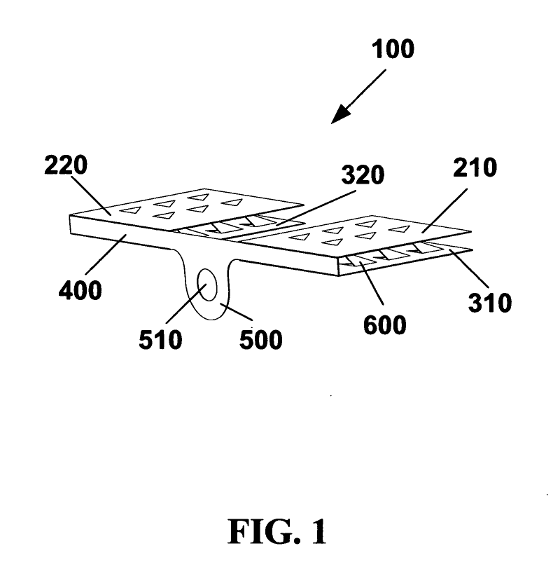

FIG. 1 illustrates a perspective view of a repair device 100 for a nonmetallic electrical outlet box, according to one embodiment of the present invention. Repair device 100 is comprised of a tab support 400 from which two sets of substantially parallel projections extend. The left-most set is comprised of a top left side tab 210 and a bottom left side tab 310. The right-most set is comprised of a top right side tab 220 and a bottom right side tab 320. Each side tab has a plurality of cleat 600 that are disposed therein, e.g. by angle and shape, to allow repair device 100 to slide onto an outlet box needing repair, and to strongly resist being removed from that outlet box. Protruding from tab support 400 from substantially the center of tab support 400 is a fastener tab 500. Fastener tab 500 is substantially perpendicular to the side tabs. Disposed within fastener tab 500 is a fastener hole 510, which is operable for engaging a corresponding fastener, e.g. screw, to secure repair device 100 to a nonmetallic electrical outlet box. Preferably fastener hole 510 is threaded with 6/32″ threads.

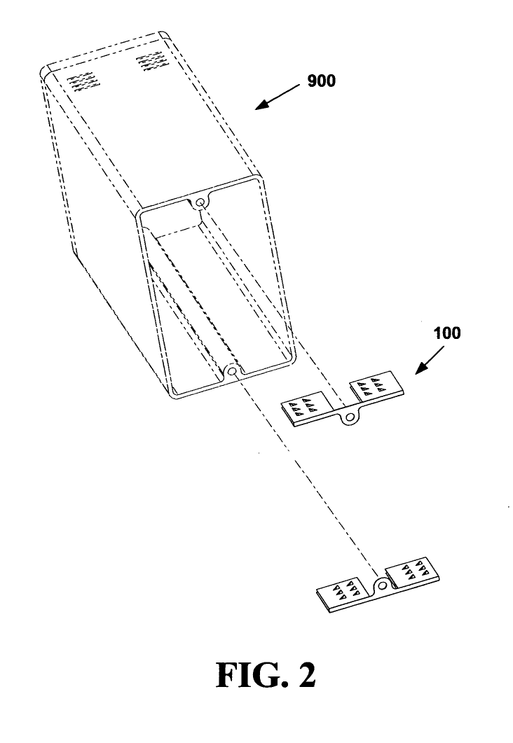

FIG. 2 illustrates a perspective view illustrating one step in the process of installing two of repair device 100 to a nonmetallic electrical outlet box 900, one at the top of nonmetallic electrical outlet box 900 and one at the bottom of electrical box 900, according to one embodiment of the present invention.

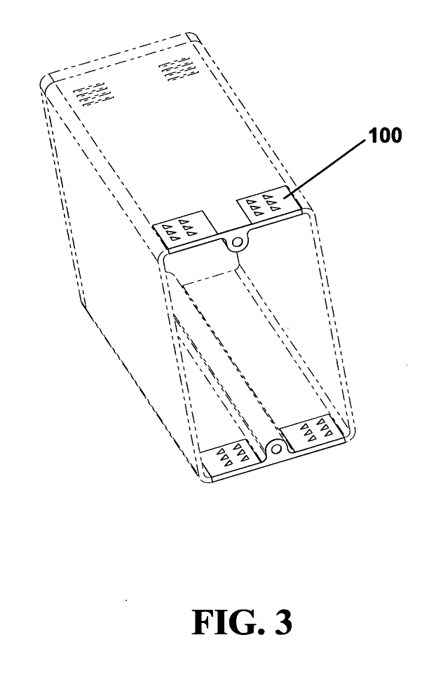

FIG. 3 illustrates a perspective view illustrating a subsequent step in the process of installing two of repair device 100, according to one embodiment of the present invention.

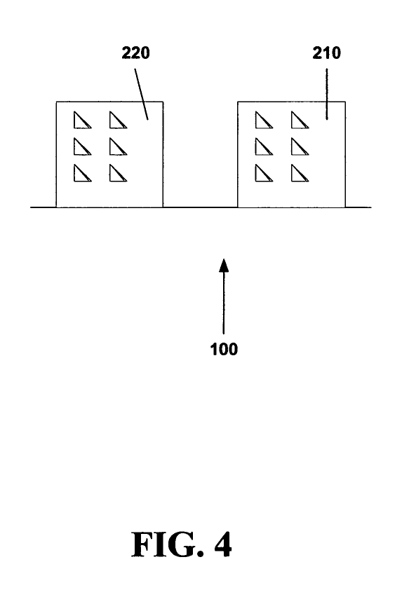

FIG. 4 illustrates a top plan view of repair device 100, according to one embodiment of the present invention. Top left side tab 210 and top right side tab 220 are also illustrated.

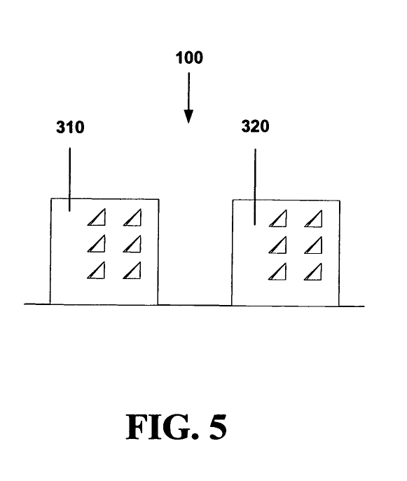

FIG. 5 illustrates a bottom plan view of repair device 100, according to one embodiment of the present invention. Bottom left side tab 310 and bottom right side tab 320 are also illustrated.

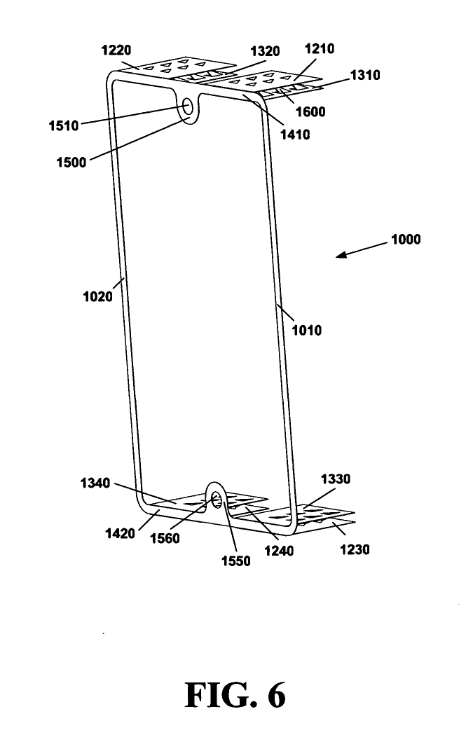

FIG. 6 illustrates a perspective view of a repair device 1000, according to one embodiment of the present invention. Repair device 1000 is formed as one piece frame with the frame consisting of two repair assemblies, as described above, with the bottom repair assembly rotated 180° in orientation to the top repair assembly, and two parallel bars. Repair device 1000 is comprised of an upper tab support 1410, which is further comprised of upper screw tab 1510, upper top left side tab 1210, upper top left side tab 1310, upper top right side tab 1220, and upper bottom right side tab 1320. Protruding from tab support 1410 from substantially the center of tab support 1410 is a fastener tab 1510. Fastener tab 1510 is substantially perpendicular to the side tabs. Disposed within fastener tab 1510 is a fastener hole 1510, which is operable for engaging a corresponding fastener, e.g. screw, to secure repair device 1000 to a nonmetallic electrical outlet box. Repair device 1000 is further comprised of a lower tab support 1420, which is further comprised of lower fastener tab 1520, lower bottom left side tab 1230, lower top left side tab 1330, lower top right side tab 1240, and lower bottom right side tab 1340. Protruding from tab support 1420 from substantially the center of lower tab support 1420 is a fastener tab 1520. Disposed within fastener tab 1520 is a fastener hole 1520, which is operable for engaging a corresponding fastener, e.g. screw, to secure repair device 1000 to a nonmetallic electrical outlet box. Each side tab has a plurality of cleat 1600 which are disposed therein to allow repair device 1000 to slide onto a nonmetallic outlet box needing repair, and to strongly resist being removed from that nonmetallic outlet box. Upper tab support 1410 and lower tab support 1420 are substantially parallel to each other. Repair device 1000 is further comprised of left side bar 1010, which protrudes from the left side of upper tab support 1410 and extends to protrude from the left side of lower tab support 1420. Similarly, repair device 1000 is further comprised of right side bar 1020, which protrudes from the right side of upper tab support 1410 and extends to protrude from the right side of lower tab support 1420. Left side bar 1010 and right side bar 1020 are substantially parallel to each other.

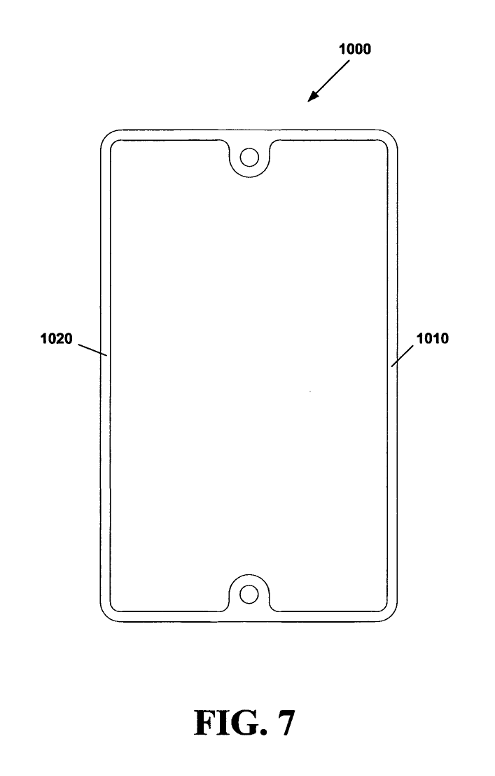

FIG. 7 illustrates a front plan view of repair device 1000. Left side bar 1010 and right side bar 1020 are also illustrated.

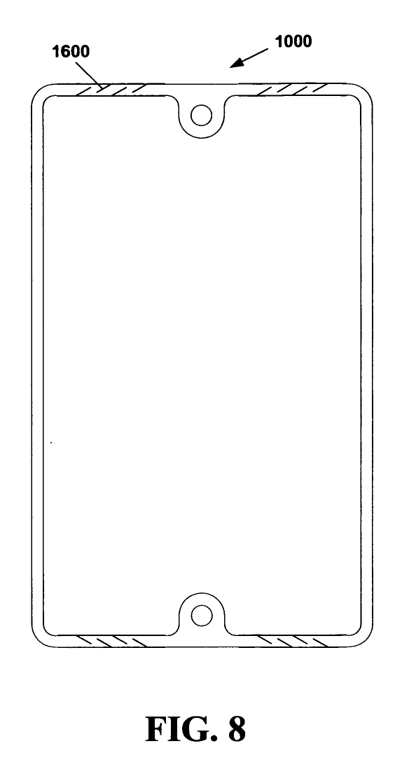

FIG. 8 illustrates a rear plan view of repair device 1000. A plurality of cleat 1600 is also illustrated.

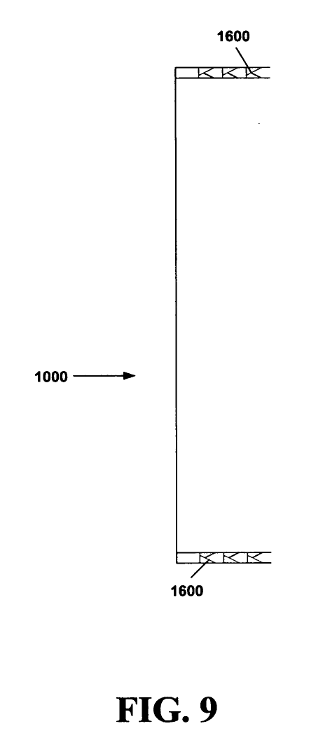

FIG. 9 illustrates a left side plan view of repair device 1000, according to one embodiment of the present invention. A plurality of cleat 1600 is also illustrated.

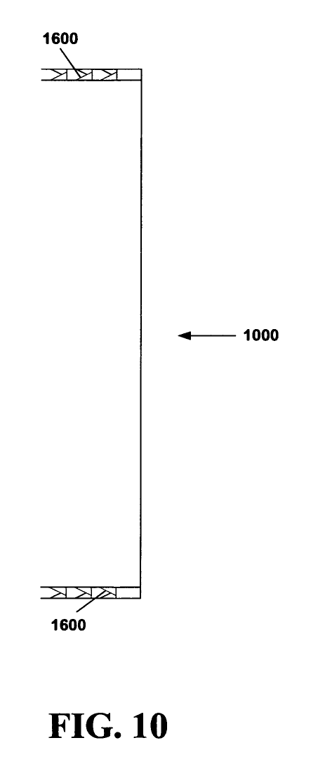

FIG. 10 illustrates a right side plan view of a repair device 1000, according to one embodiment of the present invention. A plurality of cleat 1600 is also illustrated.

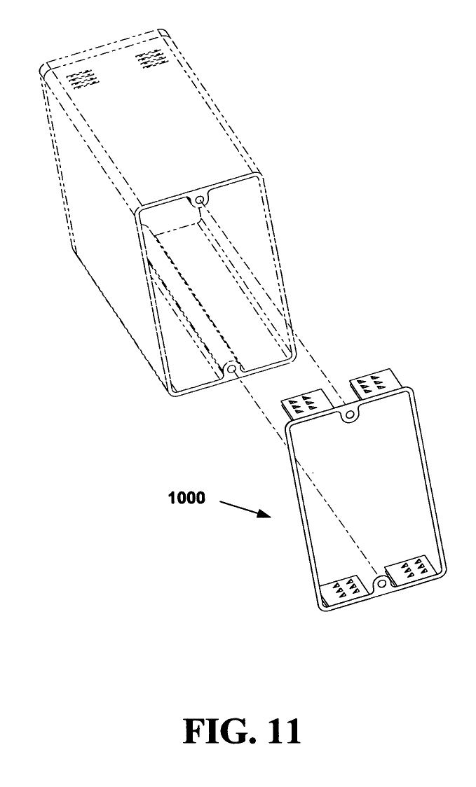

FIG. 11 illustrates a perspective view illustrating one step in the process of installing repair device 1000 to a nonmetallic electrical outlet box, according to one embodiment of the present invention.

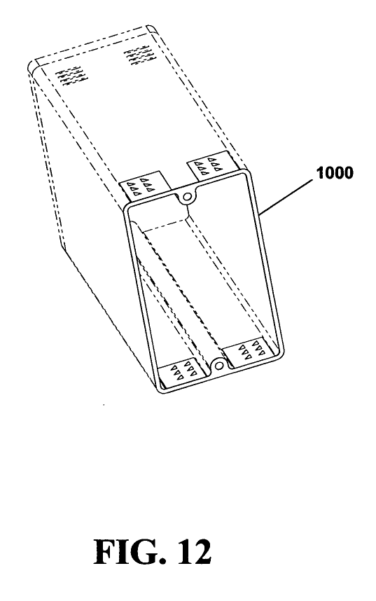

FIG. 12 illustrates a perspective view illustrating a subsequent step in the process of installing repair device 1000, according to one embodiment of the present invention.

To install a clip-embodiment of the present invention the user first turns off the power, then the user simply removes the cover plate and electrical receptacle from a nonmetallic electrical outlet box having at least one non-functional screw hole, pushes down on the electrical receptacle until there is sufficient space to insert the clip embodiment of the present invention onto the top of the nonmetallic electrical outlet box, push up on the electrical receptacle until there is sufficient space to insert the clip embodiment of the present invention onto the bottom of the nonmetallic electrical outlet box, reinstall the electrical outlet and reconnect the cover plate.

What is claimed is:

1. A nonmetallic electrical outlet box repair device for providing a replacement screw tab comprising:
means for securing onto a nonmetallic electrical outlet box; and,
means for fastening to a nonmetallic electrical outlet box.

2. The nonmetallic electrical outlet box repair device as recited in claim 1, wherein said means for securing onto a nonmetallic electrical outlet box is comprised of a tab support having at least one set of two substantially parallel side tabs protruding therefrom that are operable for fitting snugly onto a nonmetallic electrical outlet box and wherein said means for fastening to a nonmetallic electrical outlet box is comprised of a fastener tab protruding from the tab support in substantially a perpendicular orientation to the parallel side tabs, wherein the fastener tab has a threaded fastener hole that is operable for fastening the nonmetallic electrical outlet box repair device to the nonmetallic electrical outlet box.

3. The nonmetallic electrical outlet box repair device as recited in claim 3, wherein said means for securing is further comprised of serrations.

4. The nonmetallic electrical outlet box repair device as recited in claim 2, wherein said fastener hole has 6/32″ threads disposed therein.

5. A nonmetallic electrical outlet box repair device for providing two replacement screw tabs comprising:
a first electrical outlet repair assembly having a first right side and a first left side;
a second electrical outlet repair assembly substantially identical to the first electrical outlet repair assembly, wherein the second electrical outlet repair assembly is rotated 180° in orientation to the first electrical outlet assembly and having a second right side and a second left side;
a first side bar connecting the first right side to the second right side; and
a second side bar connecting the first left side to the second left side.
